(19) United States
(12) Patent Application Publication
(10) Pub. No.: US 2011/0013115 A1
(43) Pub. Date: Jan. 20, 2011

(54) LIQUID CRYSTAL DISPLAY DEVICE

(75) Inventor: Daisuke Kajita, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/836,729

(22) Filed: Jul. 15, 2010

(30) Foreign Application Priority Data
Jul. 17, 2009 (JP) 2009-169438

(51) Int. Cl. G02F 1/1335

(52) U.S. Cl. 349/61; 349/96

(57) ABSTRACT

A liquid crystal display device includes a liquid crystal display portion (6) including: a first substrate (3); a second substrate (4); a liquid crystal layer (5); a first polarizing plate (1) disposed outside of the first substrate; and a second polarizing plate (2) disposed outside of the second substrate, in which the first polarizing plate includes a first polarizing layer (1p), the second polarizing plate includes a second polarizing layer (2p), the first polarizing layer has a stretch direction (MD) that is substantially orthogonal to a stretch direction (MD) of the second polarizing layer (2p), the MD of the second polarizing layer is substantially in a long side direction of the liquid crystal display portion, and the following relation is satisfied: h₁ₚ−h₂ₚ>2 μm, where h₁ₚ is a thickness of the first polarizing layer and h₂ₚ is a thickness of the second polarizing layer.

### CROSS-REFERENCE TO RELATED APPLICATION

The present application claims priority from Japanese application JP2009-169438 filed on Jul. 17, 2009, the content of which is hereby incorporated by reference into this application.

### BACKGROUND OF THE INVENTION

1. Field of the Invention

The present invention relates to a liquid crystal display device.

2. Description of the Related Art

A liquid crystal display device has advantages of high display performance, lower power consumption, a low profile, light weight, and the like, and is now widely used in a cellular phone, a digital camera, a monitor for a personal computer (PC), a television (TV) set, and the like.

FIGS. 1 and 2 illustrate a structure of a typical liquid crystal display device. In FIG. 1, a liquid crystal display portion 6 includes a first polarizing plate 1 on a light entrance side and a second polarizing plate 2 on a light exit side. A liquid crystal layer 5 is disposed between a first substrate 3 and a second substrate 4. An electrode group is disposed on at least one of the first substrate 3 and the second substrate 4 such that voltage is applicable to the liquid crystal layer 5 with regard to each pixel. A backlight device 10 includes a light source 7, a backlight device frame member 8, and an optical element group 9.

A typical polarizing plate includes a polarizing layer having absorption anisotropy for converting incident light into linear polarization and support bases on both sides thereof. The polarizing layer is a polyvinyl alcohol (PVA) film which is stretched at a high stretch rate, and exhibits absorption anisotropy by aligning iodine in a high stretch direction. The high stretch direction of the polarizing layer is hereinafter referred to as a machine direction (MD) of the polarizing plate, while a direction orthogonal to the MD is hereinafter referred to as a transverse direction (TD) of the polarizing plate.

In a typical liquid crystal display device, the first substrate 3 and the second substrate 4 are formed of glass, and a coefficient of expansion thereof which depends on the external environment (temperature and humidity) is greatly different from those of the first polarizing plate 1 and the second polarizing plate 2. As a result, as described in Japanese Patent Application Laid-open No. 2003-279748, the liquid crystal display portion 6 warps depending on the state of the backlight device 10 (whether the power is on or off and the applied electric power) and the external environment (weather and geographic region).

With reference to FIG. 2, in a typical liquid crystal display device, the liquid crystal display portion 6 is mounted on the backlight device 10, and is fixed by a frame member 81. Therefore, if the liquid crystal display portion 6 warps to a large extent, the liquid crystal display portion 6 is brought into contact with the frame member 81 or the optical element group 9. Here, the liquid crystal display portion 6 is in a state of being locally pressed from a front side or a back side, with the result that the alignment of liquid crystal molecules in the liquid crystal layer 5 is disordered and irregularities in an image is caused.

Irregularities in an image caused by warpage of the liquid crystal display portion is expected to become more obvious in the future because a screen of a liquid crystal display device is becoming larger and the image quality of a liquid crystal display device is becoming higher in recent years. Other prior art documents which relate to the present invention include Japanese Patent Application Laid-open Nos. 2009-109860, 2009-37223, and 2009-93074.

### SUMMARY OF THE INVENTION

In a liquid crystal display device including a polarizing plate and an illuminating device, a liquid crystal display portion warps depending on the external environment to cause irregularities in an image. Accordingly, an object of the present invention is to suppress irregularities in an image caused by warpage of the liquid crystal display portion.

(1) In order to solve the above-mentioned problem, the present invention provides a liquid crystal display device including a liquid crystal display portion, the liquid crystal display portion including: a first substrate disposed on a side opposite to a display surface of the liquid crystal display portion; a second substrate disposed on a side of the display surface of the liquid crystal display portion; a liquid crystal layer sandwiched between the first substrate and the second substrate; a first polarizing plate disposed on a side of the first substrate opposite to the liquid crystal layer; and a second polarizing plate disposed on a side of the second substrate opposite to the liquid crystal layer, in which: the first polarizing plate includes a first polarizing layer mainly containing stretched polyvinyl alcohol (PVA); the second polarizing plate includes a second polarizing layer mainly containing stretched PVA; the first polarizing layer has a stretch direction (MD) that is substantially orthogonal to a stretch direction (MD) of the second polarizing layer; the MD of the second polarizing layer is substantially parallel to a long side direction of the liquid crystal display portion; and the following relation is satisfied: h₁ₚ−h₂ₚ>2 μm, where: h₁ₚ is a thickness of the first polarizing layer; and h₂ₚ is a thickness of the second polarizing layer.

(2) In order to solve the above-mentioned problem, the present invention provides a liquid crystal display device including a liquid crystal display portion, the liquid crystal display portion including: a first substrate disposed on a side opposite to a display surface of the liquid crystal display portion; a second substrate disposed on a side of the display surface of the liquid crystal display portion; a liquid crystal layer sandwiched between the first substrate and the second substrate; a first polarizing plate disposed on a side of the first substrate opposite to the liquid crystal layer; and a second polarizing plate disposed on a side of the second substrate opposite to the liquid crystal layer, in which: the first polarizing plate includes a first polarizing layer mainly containing stretched polyvinyl alcohol (PVA); the second polarizing plate includes a second polarizing layer mainly containing stretched PVA; the first polarizing layer has a stretch direction (MD) that is substantially orthogonal to a stretch direction (MD) of the second polarizing layer; the MD of the first polarizing layer is substantially parallel to a long side direction of the liquid crystal display portion; and the following relation is satisfied: h₂ₚ−h₁ₚ>2 μm, where: h₁ₚ is a thickness of the first polarizing layer; and h₂ₚ is a thickness of the second polarizing layer.

(3) Further, in the liquid crystal display device described in item (1), the following relation may be satisfied: h₁ₛ₂−h₂ₛ₂>20 μm, where: h₁ₛ₂ is a distance in a thickness direction between the first substrate and the first polarizing layer; and h₂ₛ₂ is a distance in the thickness direction between the second substrate and the second polarizing layer.

(4) Further, in the liquid crystal display device described in item (2), the following relation may be satisfied: h₂ₛ₂−h₁ₛ₂>20 μm, where: h₁ₛ₂ is a distance in a thickness direction between the first substrate and the first polarizing layer; and h₂ₛ₂ is a distance in the thickness direction between the second substrate and the second polarizing layer.

(5) Further, in the liquid crystal display device described in item (1), under an environment having a temperature in one of a range of −10° C. or higher and 10° C. or lower, and a range of 40° C. or higher and 70° C. or lower, the following Equation 1 may hold:

$$\begin{matrix}[ Equation 1 ] & \\ {h}_{1 p} ( \frac{{h}_{1 p} + {h}_{g}}{2} + {h}_{1 s 2} ) = {kh}_{2 p} ( \frac{{h}_{2 p} + {h}_{g}}{2} + {h}_{2 s 2} ) & ( 1 )\end{matrix}$$

where: h₁ₚ is the thickness of the first polarizing layer; h₂ₚ is the thickness of the second polarizing layer; h_{g} is a sum of a thickness of the first substrate and a thickness of the second substrate; h₁ₛ₂ is a distance in a thickness direction between the first substrate and the first polarizing layer; h₂ₛ₂ is a distance in the thickness direction between the second substrate and the second polarizing layer; ε_{MD} is a strain per unit length in the MD on the first polarizing layer; ε_{TD} is a strain per unit length in a direction (TD) orthogonal to the MD on the first polarizing layer; E_{MD} is a Young's modulus in the MD of the first polarizing layer; E_{TD} is a Young's modulus in the TD of the first polarizing layer; and k=(ε_{MD}E_{MD})/(ε_{TD}E_{TD}).

(6) Further, in the liquid crystal display device described in item (1), under an environment having a temperature in one of a range of −10° C. or higher and 10° C. or lower, and a range of 40° C. or higher and 70° C. or lower, the following Equation 2 may hold:

$$\begin{matrix}[ Equation 2 ] & \\ {h}_{1 p} ( \frac{{h}_{1 p} + {h}_{g}}{2} + {h}_{1 s 2} ) = \frac{1}{k} {h}_{2 p} ( \frac{{h}_{2 p} + {h}_{g}}{2} + {h}_{2 s 2} ) & ( 2 )\end{matrix}$$

where: h_{g} is a sum of a thickness of the first substrate and a thickness of the second substrate; h₁ₛ₂ is a distance in a thickness direction between the first substrate and the first polarizing layer; h₂ₛ₂ is a distance in the thickness direction between the second substrate and the second polarizing layer; ε_{MD} is a strain per unit length in the MD on the first polarizing layer; ε_{TD} is a strain per unit length in a direction (TD) orthogonal to the MD on the first polarizing layer; E_{MD} is a Young's modulus in the MD of the first polarizing layer; E_{TD} is a Young's modulus in the TD of the first polarizing layer; and k=(ε_{MD}E_{MD})/(ε_{TD}E_{TD}).

(7) Further, in the liquid crystal display device described in item (1), under an environment having a temperature in one of a range of −10° C. or higher and 10° C. or lower, and a range of 40° C. or higher and 70° C. or lower, the following Equation 3 may hold:

$$\begin{matrix}[ Equation 3 ] & \\ {h}_{1 p} ( \frac{{h}_{1 p} + {h}_{g}}{2} + {h}_{1 s 2} ) = \frac{1 + k {β}^{2}}{{β}^{2} + k} {h}_{2 p} ( \frac{{h}_{2 p} + {h}_{g}}{2} + {h}_{2 s 2} ) & ( 3 )\end{matrix}$$

where: h₁ₚ is the thickness of the first polarizing layer; h₂ₚ is the thickness of the second polarizing layer; h_{g} is a sum of a thickness of the first substrate and a thickness of the second substrate; h₁ₛ₂ is a distance in a thickness direction between the first substrate and the first polarizing layer; h₂ₛ₂ is a distance in the thickness direction between the second substrate and the second polarizing layer; ε_{MD} is a strain per unit length in the MD on the first polarizing layer; ε_{TD} is a strain per unit length in a direction (TD) orthogonal to the MD on the first polarizing layer; E_{MD} is a Young's modulus in the MD of the first polarizing layer; E_{TD} is a Young's modulus in the TD of the first polarizing layer; k=(ε_{MD}E_{MD})/(ε_{TD}E_{TD}); and β=L/b, where L is a length in a long side direction of the liquid crystal display portion, b is a length in a short side direction of the liquid crystal display portion, and L>b.

(8) Further, in the liquid crystal display device described in item (2), under an environment having a temperature in one of a range of −10° C. or higher and 10° C. or lower, and a range of 40° C. or higher and 70° C. or lower, the following Equation 4 may hold:

$$\begin{matrix}[ Equation 4 ] & \\ {h}_{1 p} ( \frac{{h}_{1 p} + {h}_{g}}{2} + {h}_{1 s 2} ) = \frac{1}{k} {h}_{2 p} ( \frac{{h}_{2 p} + {h}_{g}}{2} + {h}_{2 s 2} ) & ( 4 )\end{matrix}$$

where: h₁ₚ is the thickness of the first polarizing layer; h₂ₚ is the thickness of the second polarizing layer; h_{g} is a sum of a thickness of the first substrate and a thickness of the second substrate; ε_{MD} is a strain per unit length in the MD on the first polarizing layer; ε_{TD} is a strain per unit length in a direction (TD) orthogonal to the MD on the first polarizing layer; E_{MD} is a Young's modulus in the MD of the first polarizing layer; E_{TD} is a Young's modulus in the TD of the first polarizing layer; and k=(ε_{MD}E_{MD})/(ε_{TD}E_{TD}).

(9) Further, in the liquid crystal display device described in item (2), under an environment having a temperature in one of a range of −10° C. or higher and 10° C. or lower, and a range of 40° C. or higher and 70° C. or lower, the following Equation 5 may hold:

$$\begin{matrix}[ Equation 5 ] & \\ {h}_{1 p} ( \frac{{h}_{1 p} + {h}_{g}}{2} + {h}_{1 s 2} ) = {kh}_{2 p} ( \frac{{h}_{2 p} + {h}_{g}}{2} + {h}_{2 s 2} ) & ( 5 )\end{matrix}$$

where: h₁ₚ is the thickness of the first polarizing layer; h₂ₚ is the thickness of the second polarizing layer; h_{g} is a sum of a thickness of the first substrate and a thickness of the second substrate; h₁ₛ₂ is a distance in a thickness direction between the first substrate and the first polarizing layer; h₂ₛ₂ is a distance in the thickness direction between the second substrate and the second polarizing layer; ε_{MD} is a strain per unit length in the MD on the first polarizing layer; ε_{TD} is a strain per unit length in a direction (TD) orthogonal to the MD on the first polarizing layer; E_{MD} is a Young's modulus in the MD of the first polarizing layer; E_{TD} is a Young's modulus in the TD of the first polarizing layer; and k=(ε_{MD}E_{MD})/(ε_{TD}E_{TD}).

(10) Further, in the liquid crystal display device described in item (2), under an environment having a temperature in one of a range of −10° C. or higher and 10° C. or lower, and a range of 40° C. or higher and 70° C. or lower, the following Equation 6 may hold:

$$\begin{matrix}[ Equation 6 ] & \\ {h}_{1 p} ( \frac{{h}_{1 p} + {h}_{g}}{2} + {h}_{1 s 2} ) = \frac{{β}^{2} + k}{1 + k {β}^{2}} {h}_{2 p} ( \frac{{h}_{2 p} + {h}_{g}}{2} + {h}_{2 s 2} ) & ( 6 )\end{matrix}$$

where: h₁ₚ is the thickness of the first polarizing layer; h₂ₚ is the thickness of the second polarizing layer; h_{g} is a sum of a thickness of the first substrate and a thickness of the second substrate; h₁ₛ₂ is a distance in a thickness direction between the first substrate and the first polarizing layer; h₂ₛ₂ is a distance in the thickness direction between the second substrate and the second polarizing layer; ε_{MD} is a strain per unit length in the MD on the first polarizing layer; ε_{TD} is a strain per unit length in a direction (TD) orthogonal to the MD on the first polarizing layer; E_{MD} is a Young's modulus in the MD of the first polarizing layer; E_{TD} is a Young's modulus in the TD of the first polarizing layer; k=(ε_{MD}E_{MD})/(ε_{TD}E_{TD}); and β=L/b, where L is a length in a long side direction of the liquid crystal display portion, b is a length in a short side direction of the liquid crystal display portion, and L>b.

(11) Further, in the liquid crystal display device described in item (5), the following relation may be satisfied: (h₁ₛ₂₀−10 μm)<h₁ₛ₂<(h₁ₛ₂₀+10 μm), where: h₁ₛ₂ is a distance in a thickness direction between the first substrate and the first polarizing layer; and h₁ₛ₂₀ is h₁ₛ₂ determined by the Equation 1.

(12) Further, in the liquid crystal display device described in item (5), the following relation may be satisfied: (h₁ₚ₀−1 μm)<h₁ₚ<(h₁ₚ₀+1 μm), where: hₚ is the thickness of the first polarizing layer; and h₁ₚ₀ is a thickness of the first polarizing layer determined by the Equation 1.

(13) Further, in the liquid crystal display device described in item (1), under an environment having a temperature in one of a range of −10° C. or higher and 10° C. or lower, and a range of 40° C. or higher and 70° C. or lower, the following Equation 7 may hold:

$$\begin{matrix} [ Equation 7 ] & \\ \frac{1 + k {β}^{2}}{{β}^{2} + k} {h}_{2 p} ( \frac{{h}_{2 p} + {h}_{g}}{2} + {h}_{2 s 2} ) < {h}_{1 p} ( \frac{{h}_{1 p} + {h}_{g}}{2} + {h}_{1 s 2} ) < k {h}_{2 p} ( \frac{{h}_{2 p} + {h}_{g}}{2} + {h}_{2 s 2} ) & ( 7 )\end{matrix}$$

where: h₁ₚ is the thickness of the first polarizing layer; h₂ₚ is the thickness of the second polarizing layer; h_{g} is a sum of a thickness of the first substrate and a thickness of the second substrate; h₁ₛ₂ is a distance in a thickness direction between the first substrate and the first polarizing layer; h₂ₛ₂ is a distance in the thickness direction between the second substrate and the second polarizing layer; ε_{MD} is a strain per unit length in the MD on the first polarizing layer; ε_{TD} is a strain per unit length in a direction (TD) orthogonal to the MD on the first polarizing layer; E_{MD} is a Young's modulus in the MD of the first polarizing layer; E_{TD} is a Young's modulus in the TD of the first polarizing layer; k=(ε_{MD}E_{MD})/(E_{TD}E_{TD}); β=L/b, where L is a length in a long side direction of the liquid crystal display portion, b is a length in a short side direction of the liquid crystal display portion, and L>b; and k>(1+kβ²)/(β²+k).

(14) Further, in the liquid crystal display device described in item (1), under an environment having a temperature in one of a range of −10° C. or higher and 10° C. or lower, and a range of 40° C. or higher and 70° C. or lower, the following Equation 8 may hold:

$$\begin{matrix} [ Equation 8 ] & \\ k {h}_{2 p} ( \frac{{h}_{2 p} + {h}_{g}}{2} + {h}_{2 s 2} ) < {h}_{1 p} ( \frac{{h}_{1 p} + {h}_{g}}{2} + {h}_{1 s 2} ) < \frac{1 + k {β}^{2}}{{β}^{2} + k} {h}_{2 p} ( \frac{{h}_{2 p} + {h}_{g}}{2} + {h}_{2 s 2} ) & ( 8 )\end{matrix}$$

where: h₁ₚ is the thickness of the first polarizing layer; h₂ₚ is the thickness of the second polarizing layer; h_{g} is a sum of a thickness of the first substrate and a thickness of the second substrate; h₁ₛ₂ is a distance in a thickness direction between the first substrate and the first polarizing layer; h₂ₛ₂ is a distance in the thickness direction between the second substrate and the second polarizing layer; ε_{MD} is a strain per unit length in the MD on the first polarizing layer; ε_{TD} is a strain per unit length in a direction (TD) orthogonal to the MD on the first polarizing layer; E_{MD} is a Young's modulus in the MD of the first polarizing layer; E_{TD} is a Young's modulus in the TD of the first polarizing layer; k=(ε_{MD}E_{MD})/(ε_{TD}E_{TD}); β=L/b, where L is a length in a long side direction of the liquid crystal display portion, b is a length in a short side direction of the liquid crystal display portion, and L>b; and k<(1+kβ²)/(β²+k).

(15) Further, in the liquid crystal display device described in item (2), under an environment having a temperature in one of a range of −10° C. or higher and 10° C. or lower, and a range of 40° C. or higher and 70° C. or lower, the following Equation 9 may hold:

$$\begin{matrix} [ Equation 9 ] & \\ \frac{1}{k} {h}_{2 p} ( \frac{{h}_{2 p} + {h}_{g}}{2} + {h}_{2 s 2} ) < {h}_{1 p} ( \frac{{h}_{1 p} + {h}_{g}}{2} + {h}_{1 s 2} ) < \frac{{β}^{2} + k}{1 + k {β}^{2}} {h}_{2 p} ( \frac{{h}_{2 p} + {h}_{g}}{2} + {h}_{2 s 2} ) & ( 9 )\end{matrix}$$

where: h₁ₚ is the thickness of the first polarizing layer; h₂ₚ is the thickness of the second polarizing layer; h_{g} is a sum of a thickness of the first substrate and a thickness of the second substrate; h₁ₛ₂ is a distance in a thickness direction between the first substrate and the first polarizing layer; h₂ₛ₂ is a distance in the thickness direction between the second substrate and the second polarizing layer; ε_{MD}) is a strain per unit length in the MD on the first polarizing layer; ε_{TD} is a strain per unit length in a direction (TD) orthogonal to the MD on the first polarizing layer; E_{MD} is a Young's modulus in the MD of the first polarizing layer; E_{TD} is a Young's modulus in the TD of the first polarizing layer; k=(ε_{MD}E_{MD})/(ε_{TD}E_{TD}); β=L/b, where L is a length in a long side direction of the liquid crystal display portion, b is a length in a short side direction of the liquid crystal display portion, and L>b; and k>(1+kβ²)/(β²+k).

(16) Further, in the liquid crystal display device described in item (2), under an environment having a temperature in one of a range of −10° C. or higher and 10° C. or lower, and a range of 40° C. or higher and 70° C. or lower, the following Equation 10 may hold:

$$\begin{matrix} [ Equation 10 ] & \\ \frac{{β}^{2} + k}{1 + k {β}^{2}} {h}_{2 p} ( \frac{{h}_{2 p} + {h}_{g}}{2} + {h}_{2 s 2} ) < {h}_{1 p} ( \frac{{h}_{1 p} + {h}_{g}}{2} + {h}_{1 s 2} ) < \frac{1}{k} {h}_{2 p} ( \frac{{h}_{2 p} + {h}_{g}}{2} + {h}_{2 s 2} ) & ( 10 )\end{matrix}$$

where: h₁ₚ is the thickness of the first polarizing layer; h₂ₚ is the thickness of the second polarizing layer; h_{g} is a sum of a thickness of the first substrate and a thickness of the second substrate; h₁ₛ₂ is a distance in a thickness direction between the first substrate and the first polarizing layer; h₂ₛ₂ is a distance in the thickness direction between the second substrate and the second polarizing layer; ε_{MD} is a strain per unit length in the MD on the first polarizing layer; ε_{TD} is a strain per unit length in a direction (TD) orthogonal to the MD on the first polarizing layer; E_{MD} is a Young's modulus in the MD of the first polarizing layer; E_{TD} is a Young's modulus in the TD of the first polarizing layer; k=(ε_{MD}E_{MD})/(ε_{TD}E_{TD}); β=L/b, where L is a length in a long side direction of the liquid crystal display portion, b is a length in a short side direction of the liquid crystal display portion, and L>b; and k<(1+kβ²)/(β²+k).

(17) Further, in the liquid crystal display device described in item (1), at least one of the thickness of the first polarizing layer and the thickness of the second polarizing layer may be 30 μm or smaller.

(18) Further, the liquid crystal display device described in item 1 may further include a frame member for fixing the liquid crystal display portion in position, and space between an outermost surface on the side of the display surface of the liquid crystal display portion and the frame member may be 1.5 mm or smaller.

(19) Further, the liquid crystal display device described in item (1) may further include a backlight device disposed on the side opposite to the display surface of the liquid crystal display portion, the backlight device may include a planar optical element, the liquid crystal display portion and the backlight device may sandwich no structure for providing space therebetween, and the liquid crystal display portion may be disposed immediately above the optical element.

According to the present invention, irregularities in an image caused by warpage of the liquid crystal display portion may be suppressed.

### BRIEF DESCRIPTION OF THE DRAWINGS

In the accompanying drawings:

FIG. 1 is a diagram illustrating a structure of a liquid crystal display device of related art;

FIG. 2 is a diagram illustrating a structure of a liquid crystal display device of related art;

FIG. 3 is a conceptual diagram for describing factors which affect warpage of a liquid crystal display device;

FIG. 4 is a diagram illustrating a structure of an example of a liquid crystal display device according to the present invention;

FIG. 5 is a diagram illustrating the structure of the example of a liquid crystal display device according to the present invention;

FIG. 6 is a graph illustrating characteristics of the example of a liquid crystal display device according to the present invention;

FIG. 7 is a graph illustrating characteristics of the example of a liquid crystal display device according to the present invention;

FIG. 8 is a graph illustrating characteristics of an example of a liquid crystal display device according to the present invention;

FIG. 9 is a graph illustrating characteristics of the example of a liquid crystal display device according to the present invention;

FIG. 10 is a diagram illustrating a structure of an example of a liquid crystal display device according to the present invention;

FIG. 11 is a graph illustrating characteristics of the example of a liquid crystal display device according to the present invention;

FIG. 12 is a graph illustrating characteristics of the example of a liquid crystal display device according to the present invention; and

FIG. 13 is a diagram illustrating a structure of an example of a liquid crystal display device according to the present invention.

### DETAILED DESCRIPTION OF THE INVENTION

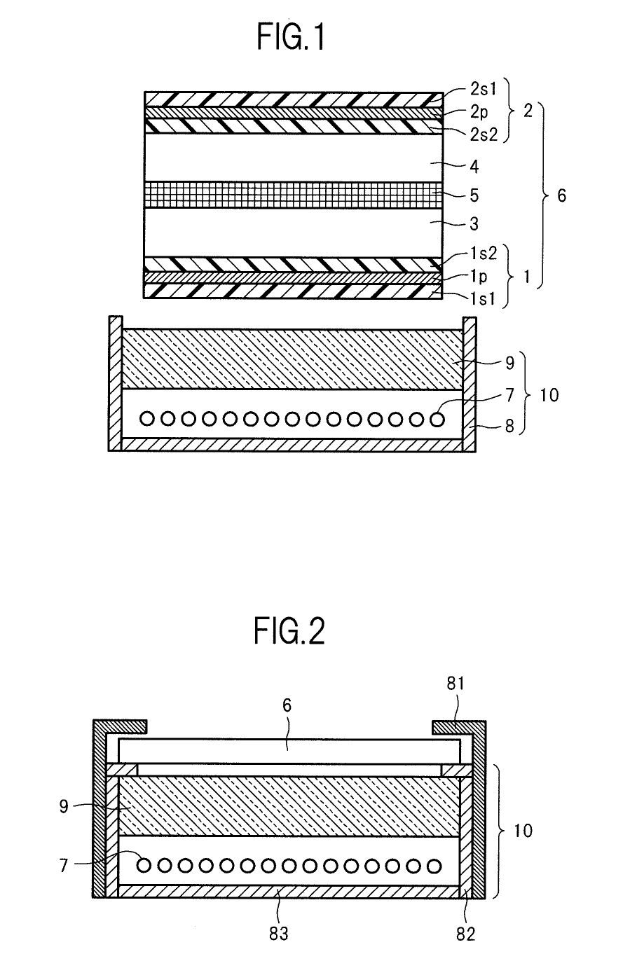

First, warpage of a liquid crystal display portion is described in detail. In the liquid crystal display portion 6 illustrated in FIG. 1, the first substrate 3 and the second substrate 4 are formed of glass, and a strain thereon (strain per unit length) is negligible compared with those of the polarizing plates. In the first polarizing plate 1 and the second polarizing plate 2, the absolute values of strains on a first polarizing layer 1p and a second polarizing layer 2p which are formed of PVA are the largest, and thus, the first polarizing layer 1p and the second polarizing layer 2p most affect the strains on the polarizing plates. According to Japanese Patent Application Laid-open No. 2009-109860 and the like, a polarizing layer strongly tends to shrink under a high temperature environment or under a high humidity environment because it is highly stretched, and the tendency to shrink is generally stronger in the MD than in the TD.

A strain ε is generally expressed by ε=αΔT/L₀, where α is a linear coefficient of expansion, ΔT is a temperature change relative to the temperature when the polarizing plate is joined to a substrate, and L₀ is the length when there is no temperature change. If the material is a metal or the like, the strain changes substantially linearly according to the temperature change. However, in particular, in case of a polarizing plate, in addition to a strain due to temperature change, a strain due to humidity change is also involved, and thus, the strain does not change linearly according to the temperature change. It follows that, in a liquid crystal display device according to the present invention, irregularities in an image caused by warpage of a liquid crystal display portion which may be suppressed under a certain environment may not be suppressed so much under another environment.

For example, because a polarizing plate is jointed to a substrate ordinarily under a room temperature environment, warpage of a liquid crystal display portion is not a serious problem under an environment close to a room temperature environment. The problem arises under an environment other than a room temperature environment in which a liquid crystal display device may be placed, for example, under an environment having a temperature in a range of −10° C. or higher and 10° C. or lower, or, 40° C. or higher and 70° C. or lower. An environment which is important differs depending on the application of the liquid crystal display device. For example, in the case of a liquid crystal display device to be mounted on a vehicle in an equatorial region, it is important to suppress warpage of a liquid crystal display portion in a high temperature of around 70° C. and high humidity environment. In this case, a strain on a polarizing plate at 70° C. is required to be considered. Then, warpage of a liquid crystal display portion at 70° C. is drastically suppressed, and thus warpage in the range of room temperature to 70° C. is also suppressed compared with a case to which the present invention is not applied.

In other words, if a structure of a liquid crystal display device according to the present invention is placed in an environment which is not a room temperature environment in which a liquid crystal display device may be placed, for example, under an environment having a temperature in a range of −10 to 10° C. or 40 to 70° C., irregularities in an image caused by warpage of a liquid crystal display portion may be suppressed. A strain on a polarizing plate under, for example, an environment of 70° C. and 40% RH herein referred to is defined as a strain per unit length on the polarizing plate when the liquid crystal display device is left under the environment of 70° C. and 40% RH for one hour relative to the polarizing plate under a reference environment. The reference environment in which no strain is put is an environment in which a polarizing plate is joined to a substrate.

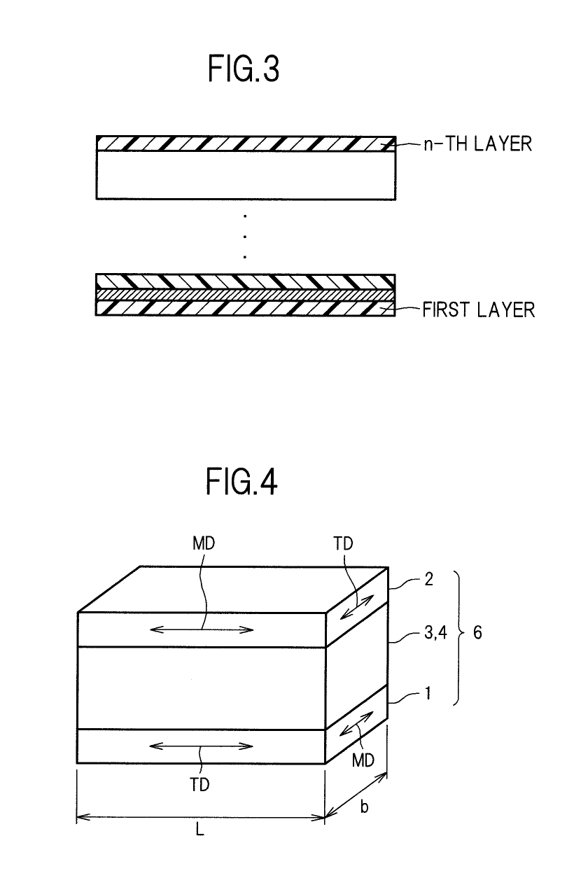

In the following, ordinary lamination is described in expressing by an approximate equation bending moment which determines warpage of a liquid crystal display portion. The following is a result of formulation by the present inventor based on mechanics of materials. FIG. 3 illustrates lamination including layers which have different strains and thicknesses. Let a strain on and a thickness of an i-th layer when the lamination is placed in a certain environment be εᵢ and hᵢ, respectively. Perpendicular force Pi which acts on each layer (in a direction which is in parallel with the plane of the drawing) is expressed by the following equation 11:

$$\begin{matrix}[ Equation 11 ] & \\ {P}_{i} = \frac{{\sum }_{j = 1}^{n} ( {ɛ}_{j} - {ɛ}_{i} ) {h}_{j} {E}_{j}}{{\sum }_{j = 1}^{n} {h}_{j} {E}_{j}} {h}_{i} {E}_{i} b & ( 11 )\end{matrix}$$

where Eᵢ is the Young's modulus of an i-th layer and b is the width of the lamination (in a direction which is perpendicular to the plane of the drawing).

By this perpendicular force, bending moment acts on the lamination. The bending moment is expressed by the following equation 12:

$$\begin{matrix}[ Equation 12 ] & \\ M = - \frac{1}{2} {\sum }_{i = 1}^{N} {P}_{i} {h}_{i} - {\sum }_{i = 2}^{N} {P}_{i} {\sum }_{j = 1}^{i - 1} {h}_{j} & ( 12 )\end{matrix}$$

An amount v of warpage at a position x in a length direction of the lamination (in the direction which is in parallel with the plane of the drawing) is determined according to the following differential equation (13). Iᵢ is a moment of inertia of area of an i-th layer. The liquid crystal display device according to the present invention suppresses the amount v of warpage by finding a control factor of the bending moment M and decreasing M.

$$\begin{matrix}[ Equation 13 ] & \\ \frac{{d}^{2} v}{d {x}^{2}} = \frac{M}{{\sum }_{i = 1}^{n} {E}_{i} {I}_{i}} & ( 13 )\end{matrix}$$

The above-mentioned theory is applied with approximation to the liquid crystal display portion 6 illustrated in FIG. 1. First, as described above, strains other than the strains on the polarizing layers formed of PVA are neglected and assumed to be zero. Further, the liquid crystal layer 5 is neglected and the first substrate 3 and the second substrate 4 are together assumed to be one glass plate. If this approximation is applied to Equation 11, then, the perpendicular force which acts on an i-th layer other than the polarizing layers is expressed by the following Equation 14. Subscripts 1p and 2p correspond to the first polarizing layer 1p and the second polarizing layer 2p, respectively, illustrated in FIG. 1.

$$\begin{matrix}[ Equation 14 ] & \\ {P}_{i} = \frac{{ɛ}_{1 p} {h}_{1 p} {E}_{1 p} + {ɛ}_{2 p} {h}_{2 p} {E}_{2 p}}{{\sum }_{j = 1}^{n} {h}_{j} {E}_{j}} & ( 14 )\end{matrix}$$

In a typical liquid crystal display portion, the first substrate 3 and the second substrate 4 are formed of glass. The thicknesses and the Young's moduli of the first substrate 3 and the second substrate 4 are larger than those of the polarizing plates and adhesive approximately by an order of magnitude. Therefore, the following approximate equation (Equation 15) is applied to an i-th layer other than the glass substrate:

$$\begin{matrix}[ Equation 15 ] & \\ \frac{{h}_{i} {E}_{i}}{{\sum }_{j = 1}^{n} {h}_{j} {E}_{j}} \approx 0 & ( 15 )\end{matrix}$$

For the same reason, the following approximate equation (Equation 16) is applied to the glass substrate. A subscript g corresponds to the substrate (h_{g} is the sum of the thicknesses of the first substrate 3 and the second substrate 4 illustrated in FIG. 1).

$$\begin{matrix}[ Equation 16 ] & \\ \frac{{h}_{g} {E}_{g}}{{\sum }_{j = 1}^{n} {h}_{j} {E}_{j}} \approx 1 & ( 16 )\end{matrix}$$

If these equations are applied to Equation 14, then the perpendicular force which acts on the layers other than the glass substrate and the polarizing layers is zero, and the perpendicular force which acts on the glass substrate is expressed by the following Equation 17:

[Equation 17]

P_{g}=(ε₁ₚh₁ₚE₁ₚ+ε₂ₚh₂ₚE₂ₚ)b (17)

Similar approximation derives the following Equation 18 which expresses the perpendicular force which acts on the first polarizing layer 1p:

[Equation 18]

P₁ₚ=−ε₁ₚh₁ₚE₁ₚb (18)

The perpendicular force which acts on the second polarizing layer 2p is expressed by the following Equation 19:

[Equation 19]

P₂ₚ=−ε₂ₚh₂ₚE₂ₚb (19)

The total sum of Eqs. 17 to 19 is zero, and no serious contradiction arises.

By substituting the determined perpendicular force into Equation 12, the bending moment is obtained. For the purpose of making it easier to grasp the phenomenon, the bending moment M is expressed using P₁ₚ and P₂ₚ. From Eqs. 17 to 19, Pg=−(P₁ₚ+P₂ₚ), and the following Equation 20 is obtained. Subscripts 1s2 and 2s2 correspond to the support base 1s2 on an inner side of the first polarizing plate and a support base 2s2 on an inner side of the second polarizing plate, respectively, illustrated in FIG. 1.

$$\begin{matrix}[ Equation 20 ] & \\ M = - {P}_{1 p} ( \frac{{h}_{1 p} + {h}_{g}}{2} + {h}_{1 s 2} ) + {P}_{2 p} ( \frac{{h}_{2 p} + {h}_{g}}{2} + {h}_{2 s 2} ) & ( 20 )\end{matrix}$$

First, in the liquid crystal display portion 6 illustrated in FIG. 1, it may be seen that the thicknesses and the Young's moduli of a support base 1s1 on an outer side of the first polarizing plate (on a side opposite to the liquid crystal layer with respect to the first polarizing layer 1p) and a support base 2s1 on an outer side of the second polarizing plate do not affect the bending moment. Japanese Patent Application Laid-open No. 2009-37223 and the like disclose that, the thickness and the Young's modulus of a support base play an important role in suppressing shrinkage of a polarizing plate. However, in a liquid crystal display portion in which a polarizing plate is joined to a glass substrate, as described above, the rigidity of the system is determined by the glass substrate, and hence, little effect is exerted. From this, it may be seen that the present invention relates to suppression of warpage of a liquid crystal display portion, and the point of view and the target thereof are different from those of suppression of change in the shape of a polarizing plate alone. For the same reason, the Young's moduli of the support base 1s2 on the inner side of the first polarizing plate and the support base 2s2 on the inner side of the second polarizing plate do not affect the bending moment, either.

On the other hand, the thicknesses of the support base 1s2 on the inner side of the first polarizing plate (on the same side of the liquid crystal layer with respect to the first polarizing layer 1p) and the support base 2s2 on the inner side of the second polarizing plate, or, the distance in a thickness direction between the first substrate 3 and the first polarizing layer 1p and the distance in the thickness direction between the second substrate 4 and second polarizing layer 2p, affect the bending moment. This is because bending moment is determined by the product of force and the distance between a layer in which the force occurs and a neutral surface. According to Equation 20, when P₂ₚ>P₁ₚ, the absolute value of the bending moment may be decreased by increasing the thickness h₁ₛ₂ of the support base 1s2 on the inner side of the first polarizing plate, or, by decreasing the thickness h₂ₛ₂ of the support base 2s2 on the inner side of the second polarizing plate. On the other hand, when P₁ₚ>P₂ₚ, the absolute value of the bending moment may be decreased by decreasing the thickness h₁ₛ₂ of the support base 1s2 on the inner side of the first polarizing plate, or, by increasing the thickness h₂ₛ₂ of the support base 2s2 on the inner side of the second polarizing plate. It may be seen that h₁ₛ₂ and h₂ₛ₂ are effective control factors for the bending moment.

It may be seen that the thickness h₁ₚ of the first polarizing layer and the thickness h₂ₚ of the second polarizing layer are also effective control factors. According to Equation 20, when P₂ₚ>P₁ₚ, the absolute value of the bending moment may be decreased by increasing the thickness h₁ₚ of the first polarizing layer 1p, or, by decreasing the thickness h₂ₚ of the second polarizing layer 2p. On the other hand, when P₁ₚ>P₂ₚ, the absolute value of the bending moment may be decreased by decreasing the thickness h₁ₚ of the first polarizing layer 1p, or, by increasing the thickness h₂ₚ of the second polarizing layer 2p. It should be noted that, when the thickness of the polarizing layer is decreased, means disclosed in Japanese Patent Application Laid-open No. 2009-93074, for example, may be used.

In the following, the phenomenon is simulated as a two-dimensional problem, and is reviewed in more detail. Reference is made to the liquid crystal display portion 6 illustrated in FIG. 4. L>b, the MD of the first polarizing plate 1 is in a direction of the width b, and the MD of the second polarizing plate 2 is in a direction of the length L. The layered structures of the first polarizing plate 1 and the second polarizing plate 2 are the same as those illustrated in FIG. 1. Let a strain on the first polarizing layer 1p in the MD be ε_{MD}, the Young's modulus thereof be E_{MD}, a strain on the first polarizing layer 1p in the TD be ε_{TD}, and the Young's modulus thereof be E_{TD}. From Eqs. 18 to 20, bending moment M_{L} which acts in the direction of L and bending moment M_{b} which acts in the direction of b are expressed by the following Equation 21. When ε_{MD}E_{MD} and ε_{TD}E_{TD} are different from each other, it is almost impossible to make both M_{L} and M_{b} equally zero. This is required to be recognized, and still, the amount of warpage is required to be suppressed. In the following, a review is made based on some design guidelines which vary depending on the application of the liquid crystal display device.

$$\begin{matrix} [ Equation 21 ] & \\ {M}_{L} = - {ɛ}_{TD} {E}_{TD} {h}_{1 p} b ( \frac{{h}_{1 p} + {h}_{g}}{2} + {h}_{1 s 2} ) + {ɛ}_{MD} {E}_{MD} {h}_{2 p} b ( \frac{{h}_{2 p} + {h}_{g}}{2} + {h}_{2 s 2} ) & ( 21 ) \\ {M}_{b} = - {ɛ}_{MD} {E}_{MD} {h}_{1 p} L ( \frac{{h}_{1 p} + {h}_{g}}{2} + {h}_{1 s 2} ) + {ɛ}_{TD} {E}_{TD} {h}_{2 p} L ( \frac{{h}_{2 p} + {h}_{g}}{2} + {h}_{2 s 2} ) & \end{matrix}$$

In Equation 13, a moment of inertia of area I is in proportion to the width (in a direction perpendicular to x). Therefore, if the effect of gravity is neglected, the largest amount of warpage in the direction of L is in proportion to M_{L}·L²/b, while the largest amount of warpage in the direction of b is in proportion to M_{b}·b²/L. Thus, W_{L} and W_{b} defined by the following Equation 22 are indicators of the amounts of warpage in the direction of L and in the direction of b, respectively. When L>b, it is clear that the amount of warpage may be suppressed more by giving a higher priority to decreasing W_{L}.

$$\begin{matrix} [ Equation 22 ] & \\ {W}_{L} = \frac{{M}_{L} {L}^{2}}{b} = - {ɛ}_{TD} {E}_{TD} {h}_{1 p} {L}^{2} ( \frac{{h}_{1 p} + {h}_{g}}{2} + {h}_{1 s 2} ) + {ɛ}_{MD} {E}_{MD} {h}_{2 p} {L}^{2} ( \frac{{h}_{2 p} + {h}_{g}}{2} + {h}_{2 s 2} ) & ( 22 ) \\ {W}_{b} = \frac{{M}_{b} {b}^{2}}{L} = - {ɛ}_{MD} {E}_{MD} {h}_{1 p} {b}^{2} ( \frac{{h}_{1 p} + {h}_{g}}{2} + {h}_{1 s 2} ) + {ɛ}_{TD} {E}_{TD} {h}_{2 p} {b}^{2} ( \frac{{h}_{2 p} + {h}_{g}}{2} + {h}_{2 s2} ) & \end{matrix}$$

A first guideline is to suppress warpage in the direction of L. In order to attain this, a condition required for W_{L}=0 to hold is determined. The condition to be satisfied by the thicknesses of the polarizing layers and the support bases is expressed by the following Equation 23:

$$\begin{matrix}[ Equation 23 ] & \\ {h}_{1 p} ( \frac{{h}_{1 p} + {h}_{g}}{2} + {h}_{1 s 2} ) = k {h}_{2 p} ( \frac{{h}_{2 p} + {h}_{g}}{2} + {h}_{2 s 2} ) & ( 23 )\end{matrix}$$

where k=(ε_{MD}E_{MD})/(ε_{TD}E_{TD}).

A second guideline is to suppress warpage in the direction of b. In order to attain this, a condition required for W_{b}=0 to hold is determined. The condition to be satisfied by the thicknesses of the polarizing layers and the support bases is expressed by the following Equation 24. Ordinarily, if priority is given to such suppression of warpage in the direction of b, the absolute value of W_{L} is increased. However, it is often the case that a drive circuit for applying a signal to the respective pixels is disposed at an edge of the liquid crystal display portion 6, and, if the liquid crystal display portion 6 warps to a large extent, a problem may arise with regard to the state of contact of the drive circuit. Therefore, when it is important to decrease W_{b} from the viewpoint of the reliability of the contact of the drive circuit, priority may be given thereto.

$$\begin{matrix}[ Equation 24 ] & \\ {h}_{1 p} ( \frac{{h}_{1 p} + {h}_{g}}{2} + {h}_{1 s 2} ) = \frac{1}{k} {h}_{2 p} ( \frac{{h}_{2 p} + {h}_{g}}{2} + {h}_{2 s 2} ) & ( 24 )\end{matrix}$$

A third guideline is to suppress warpage in a b-L plane to a same extent. Because, if W_{L} and W_{b} are of the same sign, warpage in a same direction is caused by bending moment in the same direction, W_{L} and W_{b} are required to be of opposite sign and the absolute values thereof are the same, that is, the condition is that W_{L}+W_{b}=0 holds. Here, the condition to be satisfied by the thicknesses of the polarizing layers and the support bases is expressed by the following Equation 25:

$$\begin{matrix}[ Equation 25 ] & \\ {h}_{1 p} ( \frac{{h}_{1 p} + {h}_{g}}{2} + {h}_{1 s 2} ) = \frac{1 + k {β}^{2}}{{β}^{2} + k} {h}_{2 p} ( \frac{{h}_{2 p} + {h}_{g}}{2} + {h}_{2 s 2} ) & ( 25 )\end{matrix}$$

where β=L/b.

By the method described above, without a special material or the like, warpage of the liquid crystal display portion 6 may be suppressed by factors which may be controlled comparatively easily. Further, irregularities in an image caused by warpage of the liquid crystal display portion may be suppressed with an increase in materials cost and an increase in thickness of the liquid crystal display device being suppressed and without deteriorating the display performance and increasing the power consumption of the liquid crystal display device.

Further, conventionally, when warpage of the liquid crystal display portion is a problem, as illustrated in FIG. 2, the frame member 81 and a frame member 82 are disposed such that sufficient space is provided between the liquid crystal display portion 6 and the frame member 81 or between the liquid crystal display portion 6 and the optical element group 9. However, if the space is too large, a problem of mechanical reliability arises that the liquid crystal display portion 6 is not fixed and displacement is caused. According to study by the present inventor, sufficient mechanical reliability may be secured even in a large screen liquid crystal display device which is 26-inch diagonal or larger if the space is 1.5 mm or smaller. In other words, the space between the liquid crystal display portion 6 and the frame member 81 and the space between the liquid crystal display portion 6 and the optical element group 9 described with reference to FIG. 2 may be eliminated or may be decreased, and the mechanical reliability may be improved accordingly. Further, from the viewpoint of productivity, it is preferred that the liquid crystal display portion 6 be disposed immediately above the optical element group 9.

### EXAMPLES

The present invention is described further in detail in the following by describing specific examples thereof. The following examples are merely specific examples of the present invention. The present invention is by no means limited by those examples, and various variations and modifications may be made by those skilled in the art within the technical idea disclosed herein.

### Example 1

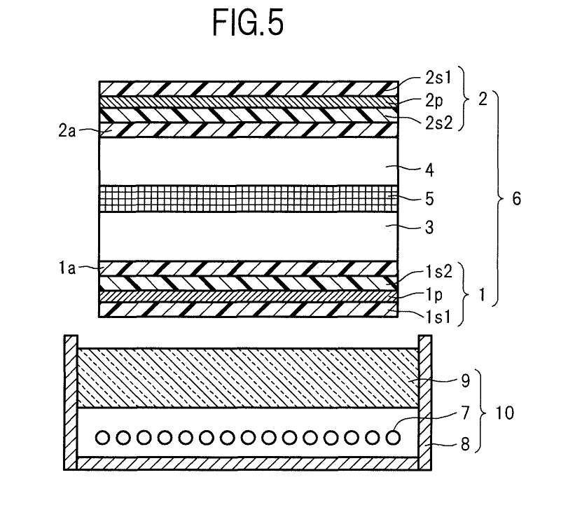

A structure of a liquid crystal display device according to Example 1 is described with reference to FIGS. 2, 4, and 5. FIG. 5 is a diagram illustrating a structure of a liquid crystal display device including the liquid crystal display portion 6 and the backlight device 10. The liquid crystal display portion 6 includes the first polarizing plate 1, the second polarizing plate 2, the first substrate 3, the second substrate 4, and the liquid crystal layer 5. The backlight device 10 includes the light source 7, the frame member 8, and the optical element group 9. The liquid crystal layer 5 is sandwiched between the first substrate 3 and the second substrate 4. A side of the liquid crystal display portion 6 which is farther from the backlight device 10 is a display surface. The first polarizing plate 1 is disposed on a side of the first substrate 3 opposite to the liquid crystal layer 5. The second polarizing plate 2 is disposed on a side of the second substrate 4 opposite to the liquid crystal layer 5. The first polarizing plate 1 includes the support base 1s2 on the inner side of the first polarizing plate, the first polarizing layer 1p, and the support base 1s1 on the outer side of the first polarizing plate. The second polarizing plate 2 includes the support base 2s2 on the inner side of the second polarizing plate, the second polarizing layer 2p, and the support base 2s1 on the outer side of the second polarizing plate. In FIG. 5, a first adhesive layer 1a is disposed between the first polarizing plate 1 and the first substrate 3 while a second adhesive layer 2a is disposed between the second polarizing plate 2 and the second substrate 4. The thickness of the first adhesive layer 1a and the second adhesive layer 2a is 20 μm. The support base 1s1 on the outer side of the first polarizing plate and the support base 2s1 on the outer side of the second polarizing plate are triacetyl cellulose (TAC) films, and the thickness of the support base 1s1 on the outer side of the first polarizing plate and the support base 2s1 on the outer side of the second polarizing plate is 80 μm. The first polarizing layer 1p and the second polarizing layer 2p are formed of PVA, and the thickness of the first polarizing layer 1p and the second polarizing layer 2p is 30 μm. The support base 1s2 on the inner side of the first polarizing plate is a TAC film, and the thickness thereof is 110 μm. The thickness of the support base 2s2 on the inner side of the second polarizing plate is 0 μm (which means that, in Example 1, the support base 2s2 on the inner side of the second polarizing plate is not disposed). With reference to FIG. 4, L=700 mm and b=400 mm. With regard to the strains on the first polarizing layer 1p and the second polarizing layer 2p, ε_{MD}=0.115 and ε_{TD}=0.1. With regard to the Young's modulus of the polarizing layers, a value 2250 MPa which is disclosed in Japanese Patent Application Laid-open No. 2003-279748 is used both in the MD and in the TD.

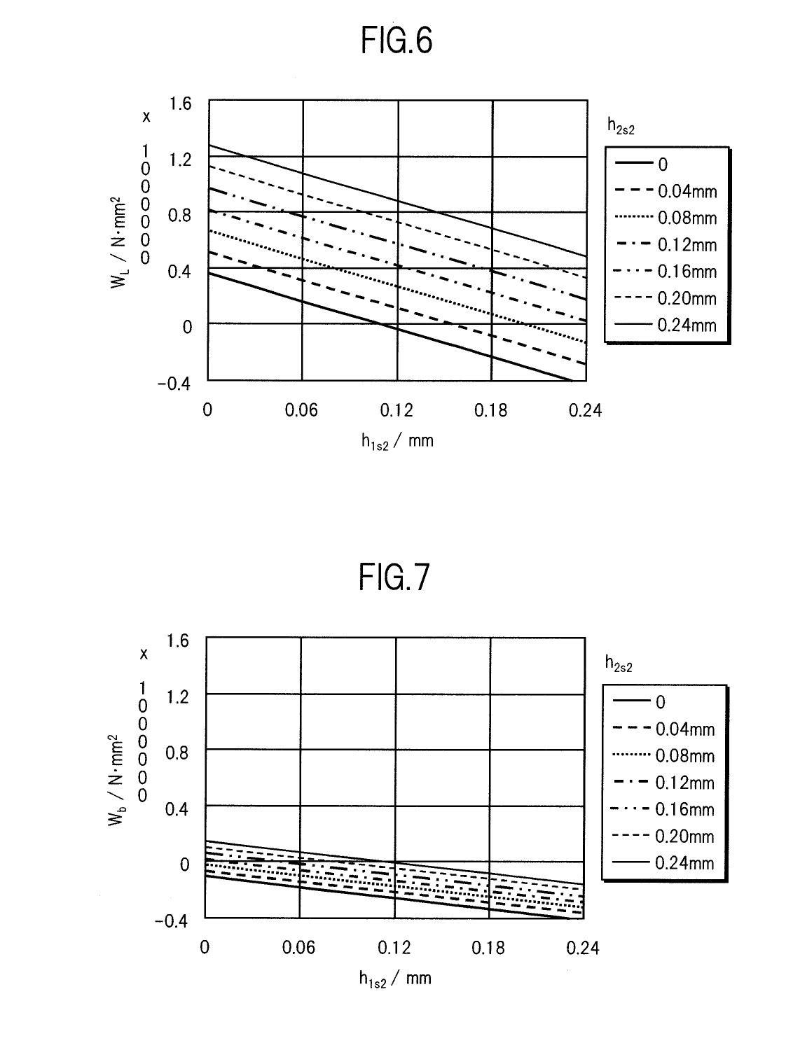

In this example, priority is given to suppression of warpage in the direction of L, and thus, the support base 2s2 on the inner side of the second polarizing plate is not used. FIGS. 6 and 7 are graphs illustrating the result of determining W_{L}, and W_{b}, respectively, with h₁ₛ₂ and h₂ₛ₂ being the parameters. It may be seen that, when the thickness of the support base changes by about 20 μm, the shape of the warpage is clearly affected. Because the first adhesive layer 1a and the second adhesive layer 2a are included in the example illustrated in FIG. 5, h₁ₛ₂ and h₂ₛ₂ in Equation 22 are replaced by h₁ₛ₂+h₁ₐ and h₂ₛ₂+h₂ₐ, respectively, where h₁ₐ and h₂ₐ are the thicknesses of the first adhesive layer 1a and the second adhesive layer 2a, respectively. More specifically, h₁ₛ₂+h₁ₐ is the distance in the thickness direction between the first substrate 3 and the first polarizing layer 1p and h₂ₛ₂+h₂ₐ is the distance in the thickness direction between the second substrate 4 and the second polarizing layer 2p. In the structure of Example 1, h₁ₛ₂=130 μm and h₂ₛ₂=20 μm. It may be seen that W_{L}, is almost zero.

Actually, in the elasticity simulation according to Eqs. 11 to 13 (not based on the approximations of Eqs. 15 and 16), the absolute value of the largest amount of warpage in the direction of L was 0.17 mm. When ordinary polarizing plates which are easily manufactured are used and h₁ₛ₂=h₂ₛ₂=80 μm, the absolute value of the largest amount of warpage is 2.8 mm, and thus, the absolute value of the largest amount of warpage according to this example is smaller. It should be noted that, in the elasticity simulation, with regard to the Young's modulus of the support bases, a value 3500 MPa which is disclosed in Japanese Patent Application Laid-open No. 2009-37223 is used. However, as described above, the Young's modulus hardly affects the amount of warpage of the liquid crystal display portion. This was also confirmed by the elasticity simulation.

As is clear from the description of this example, the thickness of an adhesive layer disposed between a polarizing layer and a substrate is not negligible. However, as described above, the effect of the Young's modulus is negligible. Therefore, a support base and an adhesive layer may be regarded as one support base as a whole the thickness of which is the sum of the thickness of the actual support base and the thickness of the adhesive layer. Conversely, when it is difficult to adjust the thickness of a support base, warpage of the liquid crystal display portion may be suppressed by changing the thickness of the adhesive layer.

### Example 2

A structure of a liquid crystal display device according to Example 2 is described with reference to FIGS. 2, 4, and 5. In FIG. 5, the first adhesive layer 1a is disposed between the first polarizing plate 1 and the first substrate 3 while the second adhesive layer 2a is disposed between the second polarizing plate 2 and the second substrate 4. The thickness of the first adhesive layer 1a and the second adhesive layer 2a is 20 μm. Both the support base 1s1 on the outer side of the first polarizing plate and the support base 2s1 on the outer side of the second polarizing plate are TAC films, and the thickness of the support base 1s1 on the outer side of the first polarizing plate and the support base 2s1 on the outer side of the second polarizing plate is 40 μm. The first polarizing layer 1p and the second polarizing layer 2p are formed of PVA, and the thickness of the first polarizing layer 1p and the second polarizing layer 2p is 30 μm. The thickness of the support base 1s2 on the inner side of the first polarizing plate is 96 μm. The thickness of the support base 2s2 on the inner side of the second polarizing plate is 40 μm. With reference to FIG. 4, L=700 mm and b=400 mm. With regard to the strains on the first polarizing layer 1p, ε_{MD}=0.115 and ε_{TD}=0.1.

In the elasticity simulation, the largest amounts of warpage in the directions of L and b were 1.5 mm and −1.4 mm, respectively. It was thus confirmed that the expected effect was obtained.

Although, in Examples 1 and 2, priority is given only to the above-mentioned guidelines 1 and 3, it is often necessary to suppress warpage of the liquid crystal display portion on the whole. Further, actually, the thickness of a general-purpose polarizing plate and the thickness of a general-purpose support base are discrete. Such realistic problems may be accommodated with a clear guideline based on the above-mentioned findings. More specifically, when k>(1+kβ²)/(β²+k), at least the following Equation 26 is required to be satisfied. This is a condition for making W_{L} and W_{b} of opposite sign and for suppressing the amount of warpage in the direction of L.

$$\begin{matrix} [ Equation 26 ] & \\ \frac{1 + k {β}^{2}}{{β}^{2} + k} {h}_{2 p} ( \frac{{h}_{2 p} + {h}_{g}}{2} + {h}_{2 s 2} ) < {h}_{1 p} ( \frac{{h}_{1 p} + {h}_{g}}{2} + {h}_{1 s 2} ) < {kh}_{2 p} ( \frac{{h}_{2 p} + {h}_{g}}{2} + {h}_{2 s 2} ) & ( 26 )\end{matrix}$$

When k<(1+kβ²)/(β²+k), the following Equation 27 is Required to be satisfied:

$$\begin{matrix} [ Equation 27 ] & \\ {kh}_{2 p} ( \frac{{h}_{2 p} + {h}_{g}}{2} + {h}_{2 s 2} ) < {h}_{1 p} ( \frac{{h}_{1 p} + {h}_{g}}{2} + {h}_{1 s 2} ) < \frac{1 + k {β}^{2}}{{β}^{2} + k} {h}_{2 p} ( \frac{{h}_{2 p} + {h}_{g}}{2} + {h}_{2 s 2} ) & ( 27 )\end{matrix}$$

### Example 3

A structure of a liquid crystal display device according to Example 3 is described with reference to FIGS. 2, 4, and 5. In FIG. 5, the first adhesive layer 1a is disposed between the first polarizing plate 1 and the first substrate 3 while the second adhesive layer 2a is disposed between the second polarizing plate 2 and the second substrate 4. The thickness of the first adhesive layer 1a and the second adhesive layer 2a is 20 μm. The support base 1s1 on the outer side of the first polarizing plate, the support base 1s2 on the inner side of the first polarizing plate, the support base 2s2 on the inner side of the second polarizing plate, and the support base 2s1 on the outer side of the second polarizing plate are all TAC films, and the thickness thereof is 80 μm. The first polarizing layer 1p and the second polarizing layer 2p are formed of PVA, and the thickness of the first polarizing layer 1p is 34 μm while the thickness of the second polarizing layer 2p is 30 μm. With reference to FIG. 4, L=700 mm and b=400 mm. With regard to the strains on the first polarizing layer 1p, ε_{MD}=0.115 and ε_{TD}=0.1.

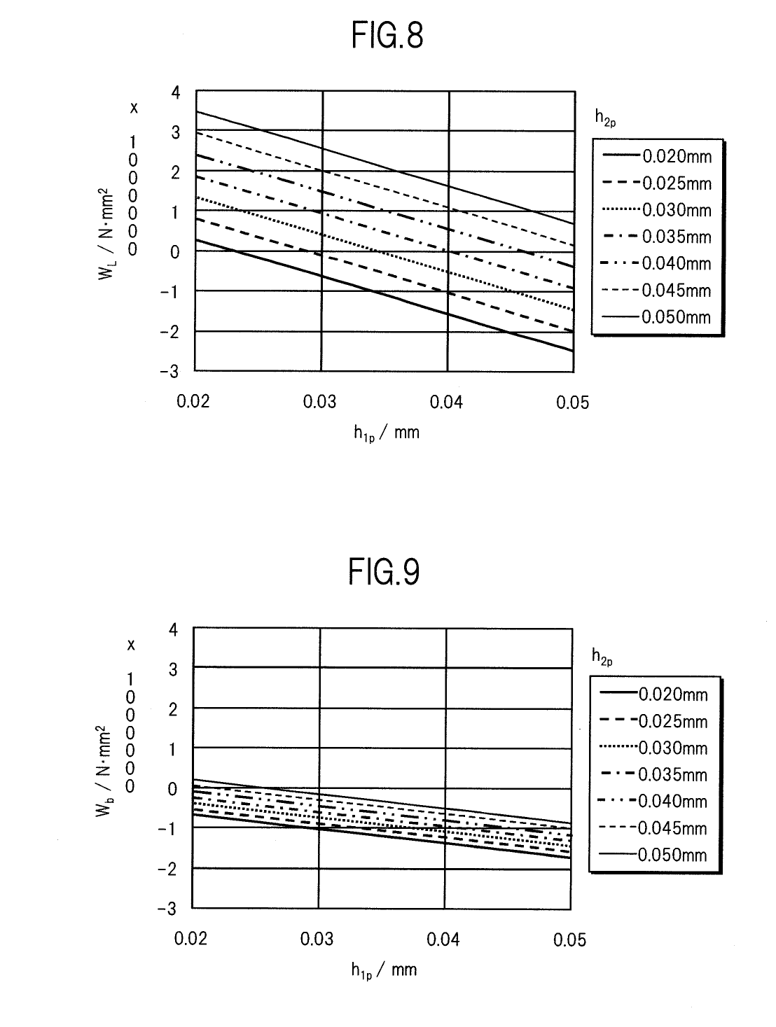

In this example, priority is given to suppression of warpage in the direction of L, and thus, the first polarizing layer 1p is made thicker than the second polarizing layer 2p. FIGS. 8 and 9 are graphs illustrating the result of determining W_{L} and W_{b}, respectively, with h₁ₚ and h₂ₚ being the parameters. It may be seen that, when the thickness of the polarizing layer changes by about 2 μm, the shape of the warpage is clearly affected. Because the first adhesive layer 1a and the second adhesive layer 2a are included in the example illustrated in FIG. 5, h₁ₛ₂ and h₂ₛ₂ in Equation 22 are replaced by h₁ₛ₂+h₁ₐ and h₂ₛ₂+h₂ₐ, respectively, where h₁ₐ and h₂ₐ are the thicknesses of the first adhesive layer 1a and the second adhesive layer 2a, respectively. In the structure of this example, it may be seen that W_{L} is almost zero.

### Example 4

A structure of a liquid crystal display device according to Example 4 is described with reference to FIGS. 2, 4, and 5. In FIG. 5, the first adhesive layer 1a is disposed between the first polarizing plate 1 and the first substrate 3 while the second adhesive layer 2a is disposed between the second polarizing plate 2 and the second substrate 4. The thickness of the first adhesive layer 1a and the second adhesive layer 2a is 20 μm. The support base 1s1 on the outer side of the first polarizing plate, the support base 1s2 on the inner side of the first polarizing plate, the support base 2s2 on the inner side of the second polarizing plate, and the support base 2s1 on the outer side of the second polarizing plate are all TAC films, and the thickness thereof is 80 μm. The first polarizing layer 1p and the second polarizing layer 2p are formed of PVA, and the thickness of the first polarizing layer 1p is 27 μm while the thickness of the second polarizing layer 2p is 25 μm. With reference to FIG. 4, L=700 mm and b=400 mm. With regard to the strains on the first polarizing layer 1p, ε_{MD}=0.115 and ε_{TD}=0.1.

In the elasticity simulation, the largest amounts of warpage in the directions of L and b were 1.1 mm and −1.2 mm, respectively. It was thus confirmed that the expected effect was obtained.

### Example 5

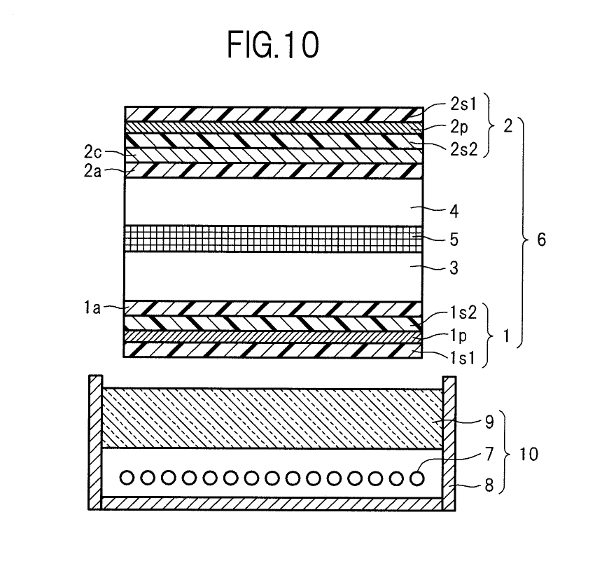

A structure of a liquid crystal display device according to Example 5 is described with reference to FIGS. 2, 4, and 10. FIG. 10 is a diagram illustrating a structure of a liquid crystal display device including the liquid crystal display portion 6 and the backlight device 10. The liquid crystal display portion 6 includes the first polarizing plate 1, the second polarizing plate 2, the first substrate 3, the second substrate 4, and the liquid crystal layer 5. The backlight device 10 includes the light source 7, the frame member 8, and the optical element group 9. The liquid crystal layer 5 is sandwiched between the first substrate 3 and the second substrate 4. A side of the liquid crystal display portion 6 which is farther from the backlight device 10 is a display surface. The first polarizing plate 1 is disposed on a side of the first substrate 3 opposite to the liquid crystal layer 5. The second polarizing plate 2 is disposed on a side of the second substrate 4 opposite to the liquid crystal layer 5. The first polarizing plate 1 includes the support base 1s2 on the inner side of the first polarizing plate, the first polarizing layer 1p, and the support base 1s1 on the outer side of the first polarizing plate. The second polarizing plate 2 includes the support base 2s2 on the inner side of the second polarizing plate, the second polarizing layer 2p, and the support base 2s1 on the outer side of the second polarizing plate. In FIG. 10, the first adhesive layer 1a is disposed between the first polarizing plate 1 and the first substrate 3 while the second adhesive layer 2a is disposed between the second polarizing plate 2 and the second substrate 4. The thickness of the first adhesive layer 1a and the second adhesive layer 2a is 20 μm. An optical phase compensation film 2c is disposed between the second polarizing plate 2 and the second substrate 4 for the purpose of improving the visual angle. The thickness h₂, of the optical phase compensation film 2c is 100 μm. The support base 1s1 on the outer side of the first polarizing plate, the support base 1s2 on the inner side of the first polarizing plate, the support base 2s2 on the inner side of the second polarizing plate, and the support base 2s1 on the outer side of the second polarizing plate are all TAC films, and the thickness thereof is 80 μm. The first polarizing layer 1p and the second polarizing layer 2p are formed of PVA, and the thickness of the first polarizing layer 1p is 32 μm while the thickness of the second polarizing layer 2p is 25 μm. With reference to FIG. 4, L=700 mm and b=400 mm. With regard to the strains on the first polarizing layer 1p, ε_{MD}=0.115 and ε_{TD}=0.1.

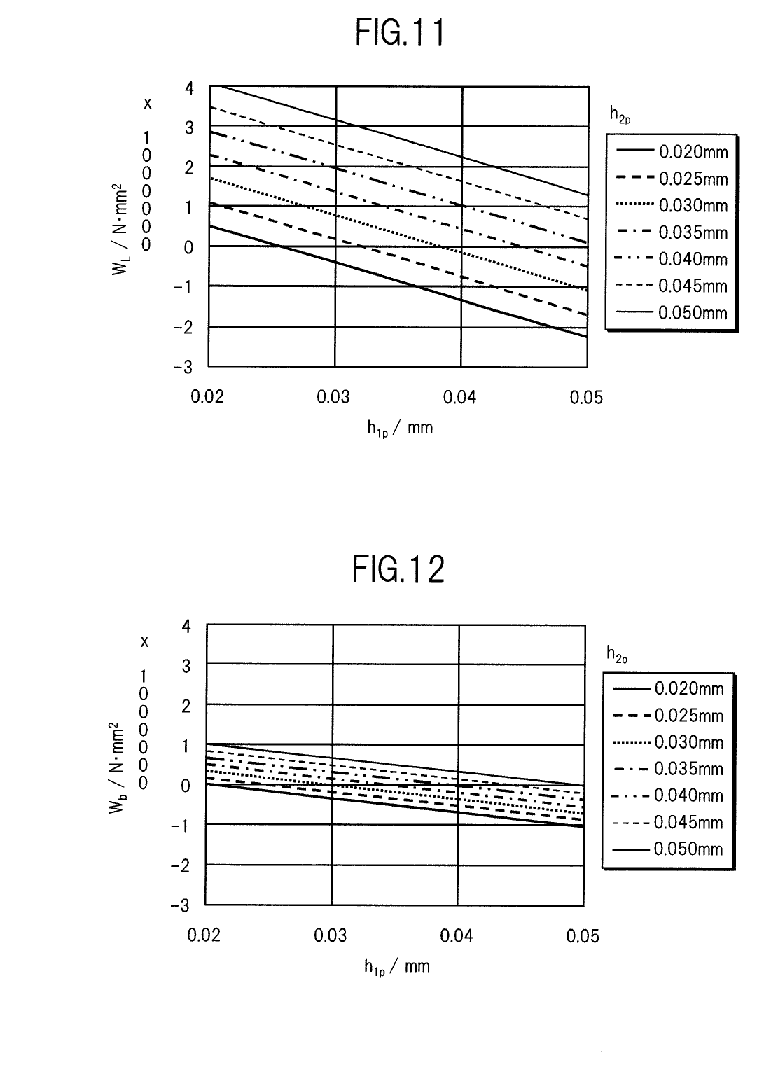

In this example, priority is given to suppression of warpage in the direction of L, and thus, the first polarizing layer 1p is made thicker than the second polarizing layer 2p. FIGS. 11 and 12 are graphs illustrating the result of determining W_{L} and W_{b}, respectively, with h₁ₚ and h₂ₚ being the parameters. Because the adhesive layers 1a and 2a are included in the example illustrated in FIG. 10, h₁ₛ₂ and h₂ₛ₂ in Equation 22 are replaced by h₁ₛ₂+h₁ₐ and h₂ₛ₂+h₂ₐ+h_{2c}, respectively, where h₁ₐ and h₂ₐ are the thicknesses of the first adhesive layer 1a and the second adhesive layer 2a, respectively. As is clear from the process of deriving Equation 22, when an optical phase compensation film is disposed, it is necessary to add the thickness of the optical phase compensation film to the thickness of the support base in Equation 22. In the structure of this example, it may be seen that W_{L} is almost zero.

In the elasticity simulation, the absolute value of the largest amount of warpage in the direction of L was 0.048 mm. When the thickness of the first polarizing layer 1p and the second polarizing layer 2p is 30 μm, the absolute value of the largest amount of warpage is 5.3 mm, and thus, the absolute value of the largest amount of warpage according to this example is smaller. It should be noted that, in the elasticity simulation, with regard to the Young's modulus of the optical phase compensation film 2c, a value 3500 MPa which is the same as that of the TAC films is used. As described above, because the Young's modulus hardly affects the amount of warpage of the liquid crystal display portion, there is no problem.

### Example 6

A structure of Example 6 is described with reference to FIGS. 2, 4, and 10. In FIG. 10, the first adhesive layer 1a is disposed between the first polarizing plate 1 and the first substrate 3 while the second adhesive layer 2a is disposed between the second polarizing plate 2 and the second substrate 4. The thickness of the first adhesive layer 1a and the second adhesive layer 2a is 20 μm. The optical phase compensation film 2c is disposed for the purpose of improving the visual angle. The thickness of the optical phase compensation film 2c is 100 μm. All of the support base 1s1 on the outer side of the first polarizing plate, the support base 1s2 on the inner side of the first polarizing plate, the support base 2s2 on the inner side of the second polarizing plate, and the support base 2s1 on the outer side of the second polarizing plate are TAC films, and the thickness thereof is 80 μm. The first polarizing layer 1p and the second polarizing layer 2p are formed of PVA. The thickness of the first polarizing layer 1p is 30 μm while the thickness of the second polarizing layer 2p is 36 μm. With reference to FIG. 4, L=700 mm and b=400 mm. With regard to the strains on the first polarizing layer 1p, ε_{MD}=0.115 and ε_{TD}=0.1.

In the elasticity simulation, the largest amounts of warpage in the directions of L and b were 1.5 mm and −1.6 mm, respectively. It was thus confirmed that the expected effect was obtained.

### Example 7

A structure of Example 7 is described with reference to FIGS. 2, 4, and 10. In FIG. 10, the first adhesive layer 1a is disposed between the first polarizing plate 1 and the first substrate 3 while the second adhesive layer 2a is disposed between the second polarizing plate 2 and the second substrate 4. The thickness of the first adhesive layer 1a and the second adhesive layer 2a is 20 μm. The optical phase compensation film 2c is disposed for the purpose of improving the visual angle. The thickness of the optical phase compensation film 2c is 100 μm. All of the support base 1s1 on the outer side of the first polarizing plate, the support base 1s2 on the inner side of the first polarizing plate, the support base 2s2 on the inner side of the second polarizing plate, and the support base 2s1 on the outer side of the second polarizing plate are TAC films, and the thickness thereof is 80 μm. The first polarizing layer 1p and the second polarizing layer 2p are formed of PVA. The thickness of the first polarizing layer 1p is 20 μm while the thickness of the second polarizing layer 2p is 24 μm. With reference to FIG. 4, L=700 mm and b=400 mm. With regard to the strains on the first polarizing layer 1p, ε_{MD}=0.115 and E_{TD}=0.1.

In the elasticity simulation, the largest amounts of warpage in the directions of L and b were 1.0 mm and −1.1 mm, respectively. It was then confirmed that the expected effect was obtained. In Example 6 and in Example 7, the thickness of the first polarizing layer 1p is not the same as the thickness of the second polarizing layer 2p and W_{L}+W_{b}=0 holds. However, the obtained absolute values of the largest amount of warpage according to this example are smaller. This is because, as may be seen from Equation 22, both the thickness of the first polarizing layer 1p and the thickness of the second polarizing layer 2p in this example are smaller than those in Example 6. As described above, it is impossible to make both W_{L} and W_{b} zero at the same time only by changing the thicknesses of the polarizing layers and the support bases. However, to make thinner the polarizing layers is effective in decreasing the absolute values of W_{L} and W_{b}. More specifically, by applying the conditions expressed by Eqs. 23 to 25, 26, and 27 while decreasing the thickness of the polarizing layers as much as possible, further effects may be obtained. It should be noted that, when the thicknesses of the polarizing layers are made to be 30 μm or less, means disclosed in Japanese Patent Application Laid-open No. 2009-93074, for example, may be used.

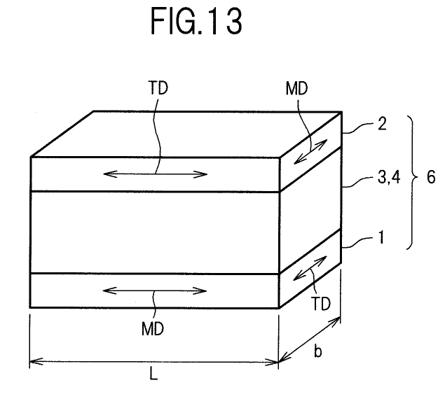

In the above-mentioned embodiments and examples, only structures in which the MD of the second polarizing plate 2 is in the direction of Las illustrated in FIG. 4 are described. However, with regard to a structure in which the MD of the first polarizing plate 1 is in the direction of L as illustrated in FIG. 13, substantially the same may be said. For example, it is enough to interchange ε_{MD}E_{MD} and ε_{TD}E_{TD} in Equation 21. Therefore, it is enough to replace k by 1/k in Eqs. 23 to 25, 26, and 27.

Further, in the above-mentioned embodiments and examples, transmissive liquid crystal display devices with the backlight device 10 as illustrated in FIGS. 1 and 2 are described as examples. However, the present invention is also applicable to a reflective liquid crystal display device without the backlight device 10 when a pair of polarizing plates are used therein.

Further, in the above-mentioned embodiments and examples, the strains on and the Young's moduli of the polarizing layers are important. However, specific values thereof are not important, and it is enough that the ratio between the MD and the TD is known. It follows that, if ε and E of one of the MD and the TD are known, by joining together a pair of polarizing plates including the same support base the Young's moduli and the like thereof being known and the aspect ratio thereof being sufficiently large such that the MDs and the TDs thereof are coincident, respectively, and by actually measuring the warpage as the environment changes, determination by calculation is possible. When the rigidity is small and a problem in handling arises, a glass plate may be sandwiched between the polarizing plates. Of course, direct measurement using a strain gage is also possible, but it should be noted that the behavior of the strain on a polarizing layer differs between a case in which the polarizing layer is directly in contact with the outside air and a case in which the polarizing layer is in contact with the outside air via a support base.

Further, in the above-mentioned embodiments and examples, the first polarizing layer and the second polarizing layer are assumed to have the same physical properties except for the thickness, especially the same strain and the same Young's modulus. However, the first polarizing layer and the second polarizing layer may have different physical properties. In such a case, by performing calculations according to the steps beginning from Equation 21 in which the strains on the first polarizing layer in the MD and the TD are expressed as ε_{1MD} and E_{1TD} respectively, the Young's moduli of the first polarizing layer in the MD and the TD are expressed as E_{1MD} and E_{1TD}, respectively, the strains on the second polarizing layer in the MD and the TD are expressed as ε_{2MD} and ε_{2TD}, respectively, and the Young's moduli of the second polarizing layer in the MD and the TD are expressed as E_{2MD} and E_{2TD}, respectively, a condition to be satisfied may be determined. For example, Equation 21 is transformed into the following Equation 28:

$$\begin{matrix} [ Equation 28 ] & \\ {M}_{L} = - {ɛ}_{1 TD} {E}_{1 TD} {h}_{1 p} b ( \frac{{h}_{1 p} + {h}_{g}}{2} + {h}_{1 s 2} ) + {ɛ}_{2 MD} {E}_{2 MD} {h}_{2 p} b ( \frac{{h}_{2 p} + {h}_{g}}{2} + {h}_{2 s 2} ) \\ {M}_{b} = - {ɛ}_{1 MD} {E}_{1 MD} {h}_{1 p} L ( \frac{{h}_{1 p} + {h}_{g}}{2} + {h}_{1 s 2} ) + {ɛ}_{2 TD} {E}_{2 TD} {h}_{2 p} L ( \frac{{h}_{2 p} + {h}_{g}}{2} + {h}_{2 s 2} ) & ( 28 )\end{matrix}$$

In Equation 23, k=(ε_{2MD}E_{2MD})/(ε_{1TD}E_{1TD}) is substituted. In Equation 24, k=(ε_{1MD}E_{1MD})/(ε_{2TD}E_{2TD}) is substituted. Equation 25 is transformed into the following Equation 29:

$$\begin{matrix} [ Equation 29 ] & \\ {h}_{1 p} ( \frac{{h}_{1 p} + {h}_{g}}{2} + {h}_{1 s 2} ) = \frac{{ɛ}_{2 TD} {E}_{2 TD} + {β}^{2} {ɛ}_{2 MD} {E}_{2 MD}}{{β}^{2} {ɛ}_{1 TD} {E}_{1 TD} + {ɛ}_{1 MD} {E}_{1 MD}} {h}_{2 p} ( \frac{{h}_{2 p} + {h}_{g}}{2} + {h}_{2 s 2} ) & ( 29 )\end{matrix}$$

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device comprising a liquid crystal display portion,
the liquid crystal display portion comprising:
a first substrate disposed on a side opposite to a display surface of the liquid crystal display portion;
a second substrate disposed on a side of the display surface of the liquid crystal display portion;
a liquid crystal layer sandwiched between the first substrate and the second substrate;
a first polarizing plate disposed on a side of the first substrate opposite to the liquid crystal layer; and
a second polarizing plate disposed on a side of the second substrate opposite to the liquid crystal layer, wherein:
the first polarizing plate comprises a first polarizing layer mainly containing stretched polyvinyl alcohol (PVA);
the second polarizing plate comprises a second polarizing layer mainly containing stretched PVA;
the first polarizing layer has a stretch direction (MD) that is substantially orthogonal to a stretch direction (MD) of the second polarizing layer;
the MD of the second polarizing layer is substantially parallel to a long side direction of the liquid crystal display portion; and
the following relation is satisfied:
h₁ₚ−h₂ₚ>2 μm, where:
h₁ₚ is a thickness of the first polarizing layer; and
h₂ₚ is a thickness of the second polarizing layer.

2. A liquid crystal display device comprising a liquid crystal display portion,
the liquid crystal display portion comprising:
a first substrate disposed on a side opposite to a display surface of the liquid crystal display portion;
a second substrate disposed on a side of the display surface of the liquid crystal display portion;
a liquid crystal layer sandwiched between the first substrate and the second substrate;
a first polarizing plate disposed on a side of the first substrate opposite to the liquid crystal layer; and
a second polarizing plate disposed on a side of the second substrate opposite to the liquid crystal layer, wherein:
the first polarizing plate comprises a first polarizing layer mainly containing stretched polyvinyl alcohol (PVA);
the second polarizing plate comprises a second polarizing layer mainly containing stretched PVA;
the first polarizing layer has a stretch direction (MD) that is substantially orthogonal to a stretch direction (MD) of the second polarizing layer;
the MD of the first polarizing layer is substantially parallel to a long side direction of the liquid crystal display portion; and
the following relation is satisfied:
h₂ₚ−h₁ₚ>2 μm, where:
h₁ₚ is a thickness of the first polarizing layer; and
h₂ₚ is a thickness of the second polarizing layer.

3. The liquid crystal display device according to claim 1, wherein the following relation is satisfied:
h₁ₛ₂−h₂ₛ₂>20 μm, where:
h₁ₛ₂ is a distance in a thickness direction between the first substrate and the first polarizing layer; and
h₂ₛ₂ is a distance in the thickness direction between the second substrate and the second polarizing layer.

4. The liquid crystal display device according to claim 2, wherein the following relation is satisfied:
h₂ₛ₂−h₁ₛ₂>20 μm, where:
h₁ₛ₂ is a distance in a thickness direction between the first substrate and the first polarizing layer; and
h₂ₛ₂ is a distance in the thickness direction between the second substrate and the second polarizing layer.

5. The liquid crystal display device according to claim 1, wherein, under an environment having a temperature in one of a range of −10° C. or higher and 10° C. or lower, and a range of 40° C. or higher and 70° C. or lower, the following Equation 1 holds:
$$\begin{matrix}[ Equation 1 ] & \\ {h}_{1 p} ( \frac{{h}_{1 p} + {h}_{g}}{2} + {h}_{1 s 2} ) = {kh}_{2 p} ( \frac{{h}_{2 p} + {h}_{g}}{2} + {h}_{2 s 2} ) & ( 1 )\end{matrix}$$
where:
h₁ₚ is the thickness of the first polarizing layer;
h₂ₚ is the thickness of the second polarizing layer;
h_{g} is a sum of a thickness of the first substrate and a thickness of the second substrate;
h₁ₛ₂ is a distance in a thickness direction between the first substrate and the first polarizing layer;
h₂ₛ₂ is a distance in the thickness direction between the second substrate and the second polarizing layer;
ε_{MD} is a strain per unit length in the MD on the first polarizing layer;
ε_{TD} is a strain per unit length in a direction (TD) orthogonal to the MD on the first polarizing layer;
E_{MD} is a Young's modulus in the MD of the first polarizing layer;
E_{TD} is a Young's modulus in the TD of the first polarizing layer; and
k=(ε_{MD}E_{MD})/(ε_{TD}E_{TD}).

6. The liquid crystal display device according to claim 1, wherein, under an environment having a temperature in one of a range of −10° C. or higher and 10° C. or lower, and a range of 40° C. or higher and 70° C. or lower, the following Equation 2 holds:
$$\begin{matrix}[ Equation 2 ] & \\ {h}_{1 p} ( \frac{{h}_{1 p} + {h}_{g}}{2} + {h}_{1 s 2} ) = \frac{1}{k} {h}_{2 p} ( \frac{{h}_{2 p} + {h}_{g}}{2} + {h}_{2 s 2} ) & ( 2 )\end{matrix}$$
where:
h_{g} is a sum of a thickness of the first substrate and a thickness of the second substrate;
h₁ₛ₂ is a distance in a thickness direction between the first substrate and the first polarizing layer;
h₂ₛ₂ is a distance in the thickness direction between the second substrate and the second polarizing layer;
ε_{MD} is a strain per unit length in the MD on the first polarizing layer;
ε_{TD} is a strain per unit length in a direction (TD) orthogonal to the MD on the first polarizing layer;
E_{MD} is a Young's modulus in the MD of the first polarizing layer;
E_{TD} is a Young's modulus in the TD of the first polarizing layer; and
k=(ε_{MD}E_{MD})/(ε_{TD}E_{TD}).

7. The liquid crystal display device according to claim 1, wherein, under an environment having a temperature in one of a range of −10° C. or higher and 10° C. or lower, and a range of 40° C. or higher and 70° C. or lower, the following Equation 3 holds:
$$\begin{matrix}[ Equation 3 ] & \\ {h}_{1 p} ( \frac{{h}_{1 p} + {h}_{g}}{2} + {h}_{1 s 2} ) = \frac{1 + k {β}^{2}}{{β}^{2} + k} {h}_{2 p} ( \frac{{h}_{2 p} + {h}_{g}}{2} + {h}_{2 s 2} ) & ( 3 )\end{matrix}$$
where:
h₁ₚ is the thickness of the first polarizing layer;
h₂ₚ is the thickness of the second polarizing layer;
h_{g} is a sum of a thickness of the first substrate and a thickness of the second substrate;
h₁ₛ₂ is a distance in a thickness direction between the first substrate and the first polarizing layer;
h₂ₛ₂ is a distance in the thickness direction between the second substrate and the second polarizing layer;
ε_{MD} is a strain per unit length in the MD on the first polarizing layer;
ε_{TD} is a strain per unit length in a direction (TD) orthogonal to the MD on the first polarizing layer;
E_{MD} is a Young's modulus in the MD of the first polarizing layer;
E_{TD} is a Young's modulus in the TD of the first polarizing layer;
k=(ε_{MD}E_{MD})/(ε_{TD}E_{TD}); and
β=L/b, where L is a length in a long side direction of the liquid crystal display portion, b is a length in a short side direction of the liquid crystal display portion, and L>b.

8. The liquid crystal display device according to claim 2, wherein, under an environment having a temperature in one of a range of −10° C. or higher and 10° C. or lower, and a range of 40° C. or higher and 70° C. or lower, the following Equation 4 holds:
$$\begin{matrix}[ Equation 4 ] & \\ {h}_{1 p} ( \frac{{h}_{1 p} + {h}_{g}}{2} + {h}_{1 s 2} ) = \frac{1}{k} {h}_{2 p} ( \frac{{h}_{2 p} + {h}_{g}}{2} + {h}_{2 s 2} ) & ( 4 )\end{matrix}$$
where:
h₁ₚ is the thickness of the first polarizing layer;
h₂ₚ is the thickness of the second polarizing layer;
h_{g} is a sum of a thickness of the first substrate and a thickness of the second substrate;
h₁ₛ₂ is a distance in a thickness direction between the first substrate and the first polarizing layer;
h₂ₛ₂ is a distance in the thickness direction between the second substrate and the second polarizing layer;
ε_{MD} is a strain per unit length in the MD on the first polarizing layer;
ε_{TD} is a strain per unit length in a direction (TD) orthogonal to the MD on the first polarizing layer;
E_{MD} is a Young's modulus in the MD of the first polarizing layer;
E_{TD} is a Young's modulus in the TD of the first polarizing layer; and
k=(ε_{MD}E_{MD})/(ε_{TD}E_{TD}).

9. The liquid crystal display device according to claim 2, wherein, under an environment having a temperature in one of a range of −10° C. or higher and 10° C. or lower, and a range of 40° C. or higher and 70° C. or lower, the following Equation 5 holds:
$$\begin{matrix}[ Equation 5 ] & \\ {h}_{1 p} ( \frac{{h}_{1 p} + {h}_{g } }{2} + {h}_{1 s 2} ) = {kh}_{2 p} ( \frac{{h}_{2 p} + {h}_{g }}{2} + {h}_{2 s 2} ) & ( 5 )\end{matrix}$$
where:
h₁ₚ is the thickness of the first polarizing layer;
h₂ₚ is the thickness of the second polarizing layer;
h_{g} is a sum of a thickness of the first substrate and a thickness of the second substrate;
h₁ₛ₂ is a distance in a thickness direction between the first substrate and the first polarizing layer;
h₂ₛ₂ is a distance in the thickness direction between the second substrate and the second polarizing layer;
ε_{MD} is a strain per unit length in the MD on the first polarizing layer;
ε_{TD} is a strain per unit length in a direction (TD) orthogonal to the MD on the first polarizing layer;
E_{MD} is a Young's modulus in the MD of the first polarizing layer;
E_{TD} is a Young's modulus in the TD of the first polarizing layer; and
k=(ε_{MD}E_{MD})/(ε_{TD}E_{TD}).

10. The liquid crystal display device according to claim 2, wherein, under an environment having a temperature in one of a range of −10° C. or higher and 10° C. or lower, and a range of 40° C. or higher and 70° C. or lower, the following Equation 6 holds:
$$\begin{matrix}[ Equation 6 ] & \\ {h}_{1 p} ( \frac{{h}_{1 p} + {h}_{g }}{2} + {h}_{1 s 2} ) = \frac{{β}^{2} + k}{1 + k {β}^{2}} {h}_{2 p} ( \frac{{h}_{2 p} + {h}_{g}}{2} + {h}_{2 s 2} ) & ( 6 )\end{matrix}$$
where:
h₁ₚ is the thickness of the first polarizing layer;
h₂ₚ is the thickness of the second polarizing layer;
h_{g} is a sum of a thickness of the first substrate and a thickness of the second substrate;
h₁ₛ₂ is a distance in a thickness direction between the first substrate and the first polarizing layer;
h₂ₛ₂ is a distance in the thickness direction between the second substrate and the second polarizing layer;
ε_{MD} is a strain per unit length in the MD on the first polarizing layer;
ε_{TD} is a strain per unit length in a direction (TD) orthogonal to the MD on the first polarizing layer;
E_{MD} is a Young's modulus in the MD of the first polarizing layer;
E_{TD} is a Young's modulus in the TD of the first polarizing layer;
k=(ε_{MD}E_{MD})/(ε_{TD}ε_{TD}); and
β=L/b, where L is a length in a long side direction of the liquid crystal display portion, b is a length in a short side direction of the liquid crystal display portion, and L>b.

11. The liquid crystal display device according to claim 5, wherein, the following relation is satisfied:
(h₁ₛ₂₀−10 μm)<h₁ₛ₂<(h₁ₛ₂₀+10 μm),
where:
h₁ₛ₂ is a distance in a thickness direction between the first substrate and the first polarizing layer; and
h₁ₛ₂₀ is h₁ₛ₂ determined by the Equation 1.

12. The liquid crystal display device according to claim 5, wherein the following relation is satisfied:
(h₁ₚ₀−1 μm)<h₁ₚ<(h₁ₚ₀+1 μm),
where:
h₁ₚ is the thickness of the first polarizing layer; and
h₁ₚ₀ is a thickness of the first polarizing layer determined by the Equation 1.

13. The liquid crystal display device according to claim 1, wherein, under an environment having a temperature in one of a range of −10° C. or higher and 10° C. or lower, and a range of 40° C. or higher and 70° C. or lower, the following Equation 7 holds:
$$\begin{matrix} [ Equation 7 ] & \\ \frac{1 + k {β}^{2}}{{β}^{2} + k} {h}_{2 p} ( \frac{{h}_{2 p} + {h}_{g}}{2} + {h}_{2 s 2} ) < {h}_{1 p} ( \frac{{h}_{1 p} + {h}_{g}}{2} + {h}_{1 s 2} ) < {kh}_{2 p} ( \frac{{h}_{2 p} + {h}_{g}}{2} + {h}_{2 s 2} ) & ( 7 )\end{matrix}$$
where:
h₁ₚ is the thickness of the first polarizing layer;
h₂ₚ is the thickness of the second polarizing layer;
h_{g} is a sum of a thickness of the first substrate and a thickness of the second substrate;
h₁ₛ₂ is a distance in a thickness direction between the first substrate and the first polarizing layer;
h₂ₛ₂ is a distance in the thickness direction between the second substrate and the second polarizing layer;
ε_{MD} is a strain per unit length in the MD on the first polarizing layer;
ε_{TD} is a strain per unit length in a direction (TD) orthogonal to the MD on the first polarizing layer;
E_{MD} is a Young's modulus in the MD of the first polarizing layer;
E_{TD} is a Young's modulus in the TD of the first polarizing layer;
k=(ε_{MD}E_{MD})/(ε_{TD}E_{TD});
β=L/b, where L is a the length in a long side direction of the liquid crystal display portion, b is a length in a short side direction of the liquid crystal display portion, and L>b; and
k>(1+kβ²)/(β²+k).

14. The liquid crystal display device according to claim 1, wherein, under an environment having a temperature in one of a range of −10° C. or higher and 10° C. or lower, and a range of 40° C. or higher and 70° C. or lower, the following Equation 8 holds:
$$\begin{matrix} [ Equation 8 ] & \\ {kh}_{2 p} ( \frac{{h}_{2 p} + {h}_{g}}{2} + {h}_{2 s 2} ) < {h}_{1 p} ( \frac{{h}_{1 p} + {hg}_{g}}{2} + {h}_{1 s 2} ) < \frac{1 + k {β}^{2}}{{β}^{2} + k} {h}_{2 p} ( \frac{{h}_{2 p} + {h}_{g}}{2} + {h}_{2 s 2} ) & ( 8 )\end{matrix}$$
where:
h₁ₚ is the thickness of the first polarizing layer;
h₂ₚ is the thickness of the second polarizing layer;
h_{g} is a sum of a thickness of the first substrate and a thickness of the second substrate;
h₁ₛ₂ is a distance in a thickness direction between the first substrate and the first polarizing layer;
h₂ₛ₂ is a distance in the thickness direction between the second substrate and the second polarizing layer;
ε_{MD} is a strain per unit length in the MD on the first polarizing layer;
ε_{TD} is a strain per unit length in a direction (TD) orthogonal to the MD on the first polarizing layer;
E_{MD} is a Young's modulus in the MD of the first polarizing layer;
E_{TD} is a Young's modulus in the TD of the first polarizing layer;
k=(ε_{MD}E_{MD})/(ε_{TD}E_{TD});
β=L/b, where L is a length in a long side direction of the liquid crystal display portion, b is a length in a short side direction of the liquid crystal display portion, and L>b; and
k<(1+kβ²)/(β²+k).

15. The liquid crystal display device according to claim 2, wherein, under an environment having a temperature in one of a range of −10° C. or higher and 10° C. or lower, and a range of 40° C. or higher and 70° C. or lower, the following Equation 9 holds:
$$\begin{matrix} [ Equation 9 ] & \\ \frac{1}{k} {h}_{2 p} ( \frac{{h}_{2 p} + {h}_{g}}{2} + {h}_{2 s 2} ) < {h}_{1 p} ( \frac{{h}_{1 p} + {h}_{g}}{2} + {h}_{1 s 2} ) < \frac{{β}^{2} + k}{1 + k {β}^{2}} {h}_{2 p} ( \frac{{h}_{2 p} + {h}_{g}}{2} + {h}_{2 s 2} ) & ( 9 )\end{matrix}$$
where:
h₁ₚ is the thickness of the first polarizing layer;
h₂ₚ is the thickness of the second polarizing layer;
h_{g} is a sum of a thickness of the first substrate and a thickness of the second substrate;
h₁ₛ₂ is a distance in a thickness direction between the first substrate and the first polarizing layer;
h₂ₛ₂ is a distance in the thickness direction between the second substrate and the second polarizing layer;
ε_{MD} is a strain per unit length in the MD on the first polarizing layer;
ε_{TD} is a strain per unit length in a direction (TD) orthogonal to the MD on the first polarizing layer;
E_{MD} is a Young's modulus in the MD of the first polarizing layer;
E_{TD} is a Young's modulus in the TD of the first polarizing layer;
k=(ε_{MD}E_{MD})/(ε_{TD}E_{TD});
β=L/b, where L is a length in a long side direction of the liquid crystal display portion, b is a length in a short side direction of the liquid crystal display portion, and L>b; and
k>(1+kβ²)/(β²+k).

16. The liquid crystal display device according to claim 2, wherein, under an environment having a temperature in one of a range of −10° C. or higher and 10° C. or lower, and a range of 40° C. or higher and 70° C. or lower, the following Equation 10 holds:
$$\begin{matrix} [ Equation 10 ] & \\ \frac{{β}^{2} + k}{1 + k {β}^{2}} {h}_{2 p} ( \frac{{h}_{2 p} + {h}_{g}}{2} + {h}_{2 s 2 } ) < {h}_{1 p} ( \frac{{h}_{1 p} + {h}_{g}}{2} + {h}_{1 s 2} ) < \frac{1}{k} {h}_{2 p} ( \frac{{h}_{2 p} + {h}_{g}}{2} + {h}_{2 s 2} ) & ( 10 )\end{matrix}$$
where:
h₁ₚ is the thickness of the first polarizing layer;
h₂ₚ is the thickness of the second polarizing layer;
h_{g} is a sum of a thickness of the first substrate and a thickness of the second substrate;
h₁ₛ₂ is a distance in a thickness direction between the first substrate and the first polarizing layer;
h₂ₛ₂ is a distance in the thickness direction between the second substrate and the second polarizing layer;
ε_{MD} is a strain per unit length in the MD on the first polarizing layer;
ε_{TD} is a strain per unit length in a direction (TD) orthogonal to the MD on the first polarizing layer;
E_{MD} is a Young's modulus in the MD of the first polarizing layer;
E_{TD} is a Young's modulus in the TD of the first polarizing layer;
k=(ε_{MD}E_{MD})/(ε_{TD}E_{TD});
β=L/b, where L is a length in a long side direction of the liquid crystal display portion, b is a length in a short side direction of the liquid crystal display portion, and L>b; and
k<(1+kβ²)/(β²+k).

17. The liquid crystal display device according to claim 1, wherein at least one of the thickness of the first polarizing layer and the thickness of the second polarizing layer is 30 μm or smaller.

18. The liquid crystal display device according to claim 1, further comprising a frame member for fixing the liquid crystal display portion in position,
wherein space between an outermost surface on the side of the display surface of the liquid crystal display portion and the frame member is 1.5 mm or smaller.

19. The liquid crystal display device according to claim 1, further comprising a backlight device disposed on the side opposite to the display surface of the liquid crystal display portion, wherein:
the backlight device comprises a planar optical element;
the liquid crystal display portion and the backlight device sandwich no structure for providing space therebetween; and
the liquid crystal display portion is disposed immediately above the planar optical element.
